(19) United States
(12) Patent Application Publication
(10) Pub. No.: US 2003/0022669 A1
(43) Pub. Date: Jan. 30, 2003

(54) Pre-paid roaming in mobile telecommunication networks

(76) Inventors: David James Aitken, Dublin (IE); Aidan Dillon, Dublin (IE)

Correspondence Address: JACOBSON HOLMAN, 400 SEVENTH STREET, N.W., WASHINGTON, DC, 20004, US

(21) Appl. No.: 10/176,374

(22) Filed: Jun. 21, 2002

Related U.S. Application Data
(63) Continuation of application No. PCT/IE00/00164, filed on Dec. 21, 2000.

(30) Foreign Application Priority Data
Dec. 23, 1999 (IE) 991093

(51) Int. Cl. H04Q 7/20

(52) U.S. Cl. 455/432; 455/422; 455/426; 455/440; 455/436

(57) ABSTRACT

A roaming subscriber transmits a feature code when in a visited network (2). The MSC (4) routes it to the home network (1), where it is intercepted by a server (5). The server (5) determines that a pre-paid call is being requested and routes a request to a pre-pay platform (7), by-passing the HLR (6). The pre-pay platform (7) sets up the call.

### FIELD OF THE INVENTION

The invention relates to provision of pre-paid roaming functionality in mobile telecommunication networks.

### PRIOR ART DISCUSSION

The provision of such functionality has been considered as part of on-going development of mobile network standards. This has arisen because of the increasing commercial importance of pre-paid use of mobile handsets and, of course, an increasing demand for roaming capability between networks such as GSM and ANSI41.

There is therefore a need to provide a system and method to provide this service.

Another object is that the service involve very little modification of existing networks.

### SUMMARY OF THE INVENTION

According to the invention, there is provided a method of providing a pre-paid roaming service to a subscriber of a home network when roaming in a visited network, the method comprising the steps of:

the subscriber dialling a feature code;

the visited network routing the code to the home network;

the home network determining that the feature code establishes pre-paid roaming eligibility for the subscriber and sets up a call (B, C, D) for the subscriber.

In one embodiment, the code is processed by a server in the home network.

Preferably, the server is connected to a home network HLR.

In one embodiment, the server intercepts the feature code signal before it reaches the HLR of the home network.

In another embodiment, the server instructs a pre-pay roaming platform to set up the call.

In a further embodiment, the server transmits required calling party and called party numbers to the pre-pay platform.

In one embodiment, a call unrelated service point in the home network server detects the feature code and instructs the pre-pay platform in a signal relaying operation.

In another embodiment, the call unrelated service point recognises SCCP headers for intercepting the code.

In a further embodiment, the server comprises a mobile services data platform.

In one embodiment, the call unrelated service point resides on the mobile services data platform providing a distribute hardware architecture.

In another embodiment, an MSC of the visited network routes the code to the home network.

According to another aspect, the invention provides a method of providing a pre-paid roaming service to a subscriber of a home network when roaming in a visited network, the method comprising the steps of:

the subscriber dialling a feature code;

an MSC of the visited network routing the code to the home network;

a server of the home network intercepting the code before it reaches a HLR of the home network;

the server transmitting an instruction to a pre-pay platform of the home network to set up a call between the subscriber and a destination number, said instruction by-passing the home network HLR; and

the pre-pay platform determining eligibility of the subscriber to set up such a call, and if eligible, setting up the call.

In one embodiment, the instruction from the server includes the subscriber's handset number and the required destination number.

According to another aspect, the invention provides a mobile network server comprising:

means for receiving signals from a foreign network,

means for recognising a feature code in said signals indicating that a subscriber roaming in the foreign network wishes to make a pre-paid call, and

means for transmitting a request for a pre-paid call to a pre-pay platform when such a feature code is detected.

In one embodiment, the server comprises means for extracting the subscriber's handset number and a required destination number from the incoming signal and for including said data in the request to the pre-pay platform.

In another embodiment, the server comprises a call unrelated service point having relaying functions residing on a mobile services data platform.

In a further embodiment, the call unrelated service point comprises an API for inspecting and manipulating Mobile Application Part protocols.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a diagram illustrating interaction of two networks for provision of pre-paid roaming services;

FIG. 2 is a diagram of the architecture of a network device for processing signals of the method shown in FIG. 1;

FIG. 3 is a diagram showing a generic HLR data structure used by a CUSP; and

FIG. 4 is a diagram showing generic routing tables.

### DESCRIPTION OF THE EMBODIMENTS

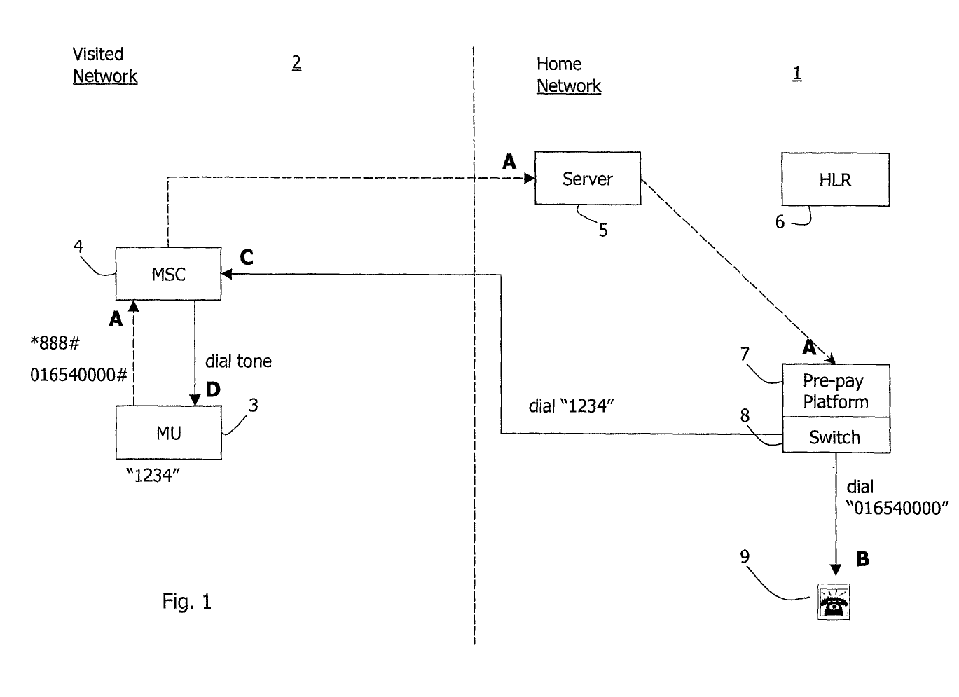

Referring to FIG. 1, a home network 1 and a visited network 2 are in this embodiment GSM. The home network 1 comprises functionality which operates in a non-invasive manner to allow a home subscriber pre-pay for mobile-originating (MO) calls when roaming in another network. This functionality is best explained with reference to the following example.

In a signalling sequence A the subscriber uses the handset 3 to dial a feature code, in this embodiment an unstructured supplementary service code *888 #016540000#. This is the code given to the subscriber for use when he or she wishes to avail of the pre-paid roaming service. An MSC 4 of the visited network relays the signal, containing the code, to the home network 1. The incoming signal in the home network 1 is received by a server 5. The server 5 filters incoming signals by recognising those of the type above and it terminates these signals and initiates a new signal to a pre-pay platform 7, bypassing the HLR 6. This filtering is performed by use of look-up tables.

This incoming signal is handled in a manner which does not affect usual operation of the home network 1 as the HLR 6 is by-passed. The platform 7 is programmed to process such transactions very efficiently, and with little effect on other operations of the networks 1 or 2.

The signal to the pre-pay platform provides the following information:

the handsets own number; and

the required destination number.

The platform 7 determines eligibility of the subscriber for the requested pre-paid roaming service. If eligible, it sets up a call, implemented by signals B, C, and D, between the handset 3 and the destination number.

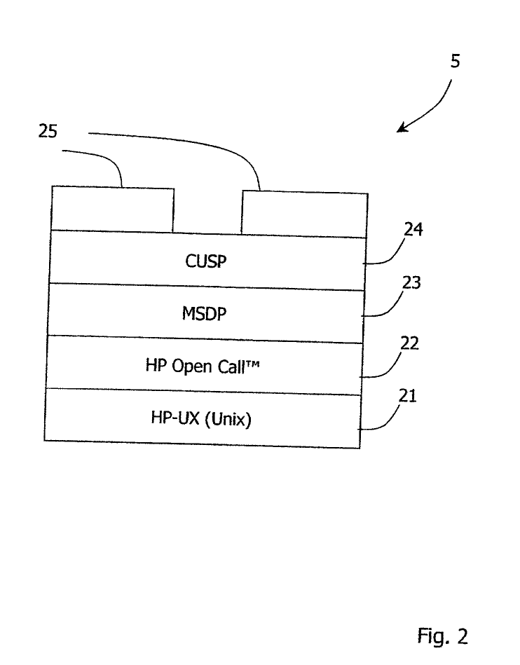

The relaying functionality in the home network server 5 is provided by a call unrelated service point (CUSP) in which basic triggering is based on the SCCP header. The CUSP may alternatively intercept all feature code signals before they reach the home HLR. The CUSP resides on a mobile services data platform (MSDP) as a signalling relay. The architecture is shown in FIG. 2. The layers are, from bottom up:

| | |
|---|---|
| 21: | a HP-UX (Unix) hardware platform; |
| 22: | a HPOpen Call ™ signalling system; |
| 23: | MSDP; |
| 24: | CUSP; and |
| 25: | application logic modules, including a pre-paid roaming module. |

In this architecture, the CUSP 24 provides an API for inspecting and manipulating Mobile Application Part (MAP) protocols, including GSM and ANSI-41. For rapid trigger logic analysis a function within CUSP provides the MAP operation type. Each application module 25 is an independent UNIX process which may be started and stopped independently of other applications on the same platform.

The MSDP 23 is a powerful, high availability platform for implementing SS7 SCCP and TCAP based applications. It is primarily oriented towards the mobile application protocols of GSM & ANSI 41 (and PDC), for which APIs are provided, however it is equally capable of supporting intelligent network INAP protocols.

The server 5 is equipped with a high speed, real-time database, which can support many millions of subscriber or routing records. The size and complexity of the real-time database is dependent on the application. For management purposes data is also maintained on disk in a SQL relational database (but this is not used by the real-time application logic).

For very high service availability, the MSDP 23 is deployed in a fault-tolerant, distributed architecture over multiple sites, supporting both system and site redundancy. The server 5 is equipped with a comprehensive operations and management module, which provides a single point of access for all management operations, including data provisioning.

For excellent flexibility, trigger and service logic modules may be written in SDL and C, for which an internal API is available.

For invocation of external SCF/SDF functions, a wide range of protocols are available to applications, including:

MAP. Typically MAP may be used to forward a message or to query an HLR, for example an ANY_TIME_INTERROGATION or an SRI_SM operation.

INAP. CS-1/2 INAP is available for querying an external service data point. Additional messages may easily be added to the message library for other kinds of query.

Any commonly available TCP/IP or X.25 based protocol stack.

CORBA

SQL

The CUSP 24 can modify a MAP payload even when relaying at the SCCP level. This will permit minor protocol conversion to be performed on the fly. The MSDP and, therefore, CUSP 24 subscription database is constructed on the concepts of an HLR. All entry may be dual keyed by MSISDN or IMSI (MDN & MIN in ANSI 41) or equivalents. An entry is made up of packages of data. Each package provides an element of functionality. An application may comprise a number of related packages. All applications share the same subscription database, using the necessary packages.

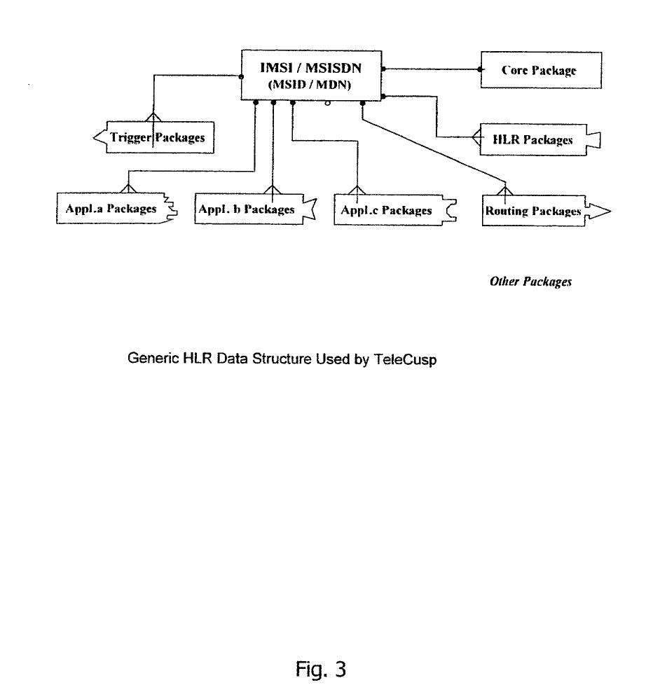

FIG. 3 shows the generic data structure that is used by CUSP applications in the layer 2 of the server 5. For ease of management, application specific routing tables are also maintained within the same structure, using special pseudo IMSIs as the key and special routing packages.

CUSP supports general purpose number analysis and routing tables that can be used to perform basic relaying of SCCP messages that do not require special routing by applications. These tables effectively provide global title translation functionality and are organised by translation type. The tables for standard translation types are used for efficient relaying of messages when no trigger logic is invoked. They are available to trigger logic. Special application specific tables (i.e. special translation types) may be defined for application specific routing.

Applications may, of course, have their own routing information database. For example, a general purpose GSM address register or a mobile number portability application will have packages containing routing tables for specific MSISDNs or IMSIs. Typically, if an entry is not found in the database, the application may relay using the general routing tables.

Although it is possible for application routing data to use point codes, it is strongly recommended that all application routing is performed using logical addresses (i.e. global title), which can then be translated by the generic title translation facilities. This avoids having to change application data in the event of reconfiguration of the SS7 routing.

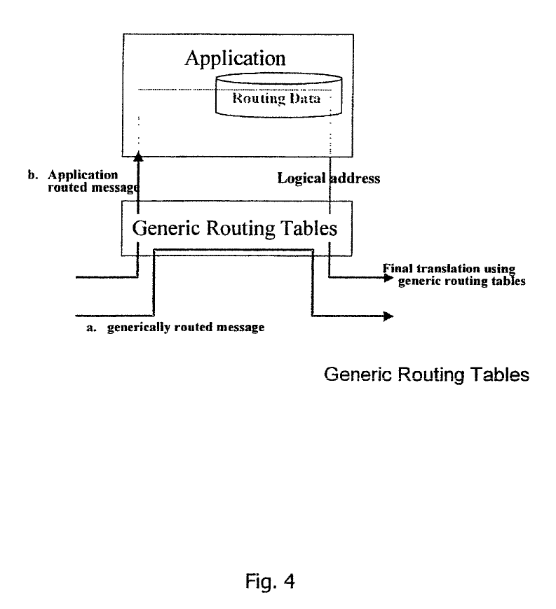

FIG. 4 shows the role of the generic routing tables. They are used for handling all incoming and outgoing messages. An incoming message is analysed and routed according to its SCCP/MTP address. The tables are used both for onward routing and to select the application. Onward routing by the applications is usually by logical address (i.e. global title), which, if necessary, may then be translated using the generic routing tables. Where the application sends a reply to the original message, the originating address is, of course, used.

The MSDP 23 supports very high availability fault tolerant configurations, mated pairs, etc. The CUSP 24 can be implemented on any suitable configuration supported by the MSDP 23. In a typical configuration two or more separate platforms are deployed in a redundant configuration at geographically separate sites.

The invention is not limited to the embodiments described, but may be varied in construction and detail. For example the same functionality may be provided in a non-GSM home network in which the relevant feature codes perform equivalent functions.

1. A method of providing a pre-paid roaming service to a subscriber of a home network when roaming in a visited network, the method comprising the steps of:
the subscriber (3) dialling a feature code;
the visited network (2) routing the code to the home network (1);
the home network (1) determining that the feature code establishes pre-paid roaming eligibility for the subscriber and sets up a call (B, C, D) for the subscriber.

2. A method as claimed in claim 1, wherein the code is processed by a server in the home network.

3. A method as claimed in claim 2, wherein the server (5) is connected to a home network HLR.

4. A method as claimed in claim 1, wherein the server (5) intercepts the feature code signal before it reaches the HLR (6) of the home network (1).

5. A method as claimed in claim 2, wherein the server (5) instructs a pre-pay roaming platform (7) to set up the call.

6. A method as claimed in claim 5, wherein the server (5) transmits required calling party and called party numbers to the pre-pay platform (7).

7. A method as claimed in claim 2, wherein a call unrelated service point (24) in the home network server detects the feature code and instructs the pre-pay platform in a signal relaying operation.

8. A method as claimed in claim 7, wherein the call unrelated service point recognises SCCP headers for intercepting the code.

9. A method as claimed in claims 7 or 8, wherein the server comprises a mobile services data platform (23).

10. A method as claimed in claims 7, wherein the call unrelated service point resides on the mobile services data platform providing a distribute hardware architecture.

11. A method as claimed in claim 1, wherein an MSC of the visited network routes the code to the home network.

12. A method of providing a pre-paid roaming service to a subscriber of a home network when roaming in a visited network, the method comprising the steps of:
the subscriber dialling a feature code;
an MSC of the visited network routing the code to the home network;
a server of the home network intercepting the code before it reaches a HLR of the home network;
the server transmitting an instruction to a pre-pay platform of the home network to set up a call between the subscriber and a destination number, said instruction by-passing the home network HLR; and
the pre-pay platform determining eligibility of the subscriber to set up such a call, and if eligible, setting up the call.

13. A method as claimed in claim 12, wherein the instruction from the server includes the subscriber's handset number and the required destination number.

14. A mobile network server comprising:
means for receiving signals from a foreign network,
means for recognising a feature code in said signals indicating that a subscriber roaming in the foreign network wishes to make a pre-paid call, and
means for transmitting a request for a pre-paid call to a pre-pay platform when such a feature code is detected.

15. A mobile network server as claimed in claim 14, wherein the server comprises means for extracting the subscriber's handset number and a required destination number from the incoming signal and for including said data in the request to the pre-pay platform.

16. A mobile network server as claimed in claim 14 or 15, wherein the server comprises a call unrelated service point having relaying functions residing on a mobile services data platform.

17. A mobile network server as claimed in claim 16, wherein the call unrelated service point comprises an API for inspecting and manipulating Mobile Application Part protocols.

18. A computer program product comprising software code portions for providing a server as claimed in claim 14, when executing on a digital computer.
